(19) United States
(12) Patent Application Publication
(10) Pub. No.: US 2013/0073360 A1
(43) Pub. Date: Mar. 21, 2013

(54) SYSTEM AND METHOD FOR PRESENTING VIDEO CONTENT IN AN ONLINE ENVIRONMENT

(71) Applicant: Jared L. Caplan, Dallas, TX (US)

(72) Inventor: Jared L. Caplan, Dallas, TX (US)

(21) Appl. No.: 13/300,490

(22) Filed: Nov. 18, 2011

Related U.S. Application Data
(63) Continuation-in-part of application No. 13/234,140, filed on Sep. 15, 2011.

(51) Int. Cl. G06F 15/16; G06Q 30/02

(52) U.S. Cl. 705/14.16; 709/219

(57) ABSTRACT

In one embodiment, a method is provided for presenting a plurality of video content in an online environment accessible by a plurality of users. According to a first step, the organization accesses a plurality of content from one or more content providers. In a next step, the organization receives a flowchart for navigating a plurality of playback sequences. The flowchart includes media content modules capable of accessing the content and decision modules for selecting a subset of media content modules. In an additional step, the organization presents a graphical representation of the playback sequences. In a further step, the organization uses a content ranking engine for delivering at least a portion of the playback sequences.

### CROSS REFERENCE TO RELATED APPLICATIONS

This application claims priority to U.S. application Ser. No. 13/234,140, filed on Sep. 15, 2011, and hereby incorporates by reference in its entirety all of its teachings.

### TECHNICAL FIELD OF THE INVENTION

The present invention relates generally to providing dynamic playback sequences of video content and, more particularly, to presenting video content having a bracket format in an online environment.

### BACKGROUND OF THE INVENTION

A major problem faced by film directors and producers and gaming developers is how to provide premium, interactive video content online. While the film industry offers premium cinematic content, the film industry lags behind in the offering of interactive content. While the gaming industry offers interaction among garners, the gaming industry lags behind in the offering of premium cinematic content such as films starring popular actors and actresses.

The introductions of the internet and worldwide web have unleashed new opportunities for collaboration between the film industry and the gaming industry. Today, popular actors, and actresses gain recognition for their work among fans, friends and friends-of-friends using online art communities, social networking websites and other communication media. Fans and talent scouts can now gain unparalleled access to their favorite actors and actresses and discover new ones. The proliferation of the internet and other communication networks permits rapid and effective communications between any number and type of organizations, artists, charities, fans, sponsors, etc. Moreover, it is well known that websites make money from advertisers when users of websites click on advertisements. The more users that click on the advertisement, the more money the website may make. However, existing technology for film directors and producers and gaming developers seeking to promote their works has yet to fully exploit the current and anticipated advances.

### SUMMARY OF THE INVENTION

In accordance with the present invention, techniques for presenting media content are provided. In one embodiment, a method is provided for presenting a plurality of media content in an online environment accessible by a plurality of users. The method includes accessing a first plurality of content from one or more first content providers, receiving a flowchart for navigating a plurality of playback sequences, presenting a graphical representation of the playback sequences and delivering a portion of the playback sequences. An exemplary flowchart includes a first plurality of media content modules operable to access the first plurality of content and a plurality of decision modules for selecting and ordering a subset of the first plurality of content capable of accessing the content and decision modules for selecting a subset of media content modules such as, for example, one or more next media content modules and/or decision modules. In another embodiment, the method includes rating the content and/or ranking the playing sequences.

Particular embodiments of the invention may provide one or more technical advantages. As an example, particular embodiments may provide new systems and methods for ranking video content in an online competition based on votes submitted online from fans. As another example, particular embodiments may provide new systems and methods for recruiting fans using social networking connections. As a further example, particular embodiments may provide new systems and methods for promoting video content using a bracket competition format for each of multiple rounds of a competition.

Other technical advantages of the present invention will be readily apparent to one skilled in the art from the following FIGURES, descriptions and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is made to the following description, taken in conjunction with the accompanying drawings, in which:

FIG. 1 illustrates an exemplary system for generating media content;

FIG. 2a illustrates an exemplary allocation of revenues of an organization among artists, charities, champions and the organization;

FIG. 2b illustrates an exemplary allocation of revenues of an organization among artist successes, charitable contributions and organization revenues;

FIG. 3 illustrates an exemplary content ranking engine for ranking art in an art competition;

FIG. 4 illustrates an exemplary flowchart for use in presenting media content;

FIG. 5 illustrates an exemplary method for generating artist successes and charitable contributions by leveraging social networking connections;

FIG. 6a illustrates an exemplary media content uploader for use in presenting media content;

FIG. 6b illustrates an exemplary media content uploader for use in presenting media content;

FIG. 7 illustrates an exemplary graphical user interface for registering media content;

FIG. 8 illustrates an exemplary graphical user interface for a user account;

FIG. 9 illustrates an exemplary media content viewer for use in presenting media content and content ratings;

FIG. 10 illustrates an exemplary media content viewer for use in modifying an exemplary flowchart;

FIG. 11 illustrates an exemplary media content organizer for use in modifying an exemplary flowchart;

FIG. 12a illustrates an exemplary flowchart tool for use in navigating playback sequences; and

FIG. 12b illustrates an exemplary flowchart for use in navigating playback sequences.

FIG. 13 illustrates an exemplary method for presenting media content; and

FIG. 14 illustrates an exemplary method for navigating playback sequences.

### DETAILED DESCRIPTION OF THE INVENTION

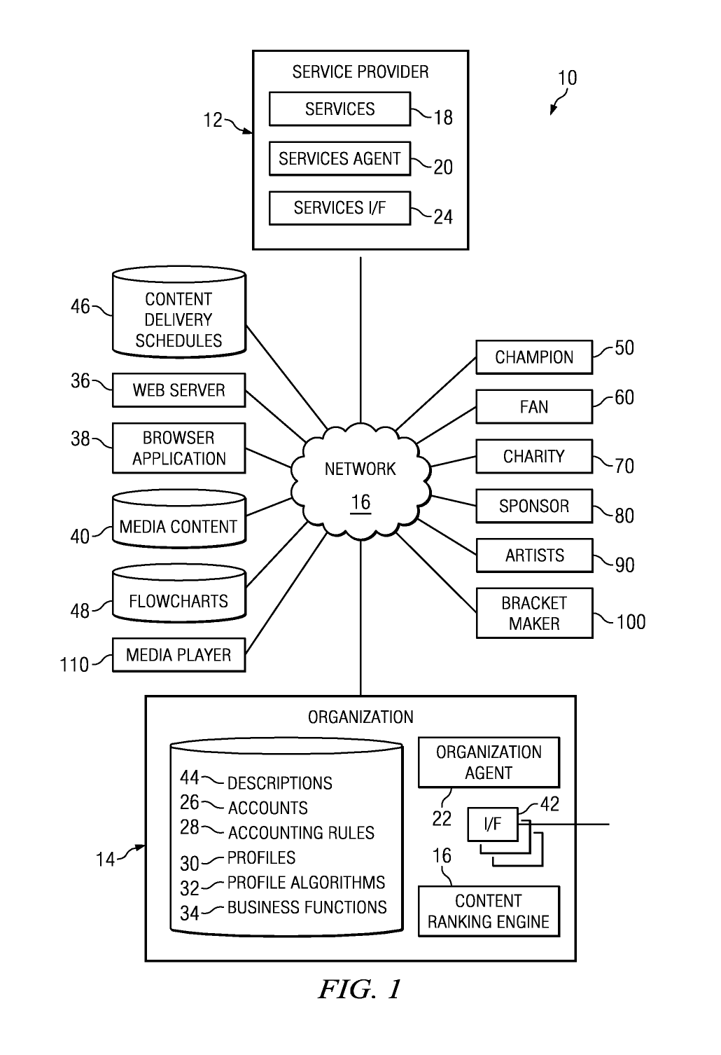

FIG. 1 illustrates a system, indicated generally at 10, that includes one or more art service providers 12 and one or more organizations 14 interconnected by a communications network 16. Art service providers 12 offer art services 18, such as art uploading, art creation and/or art viewing, potentially using service agents 20 to facilitate offering of art services 18 to one or more organizations 14 and a plurality of users of organizations 14. According to particular embodiments, organization 14 may include one or more organization agents 22 that facilitate interaction between users and art services 18 to accomplish one or more business functions 34 of organization 14. According to particular embodiments, organization agent 22 interacts with other elements of system 10 to accomplish business functions 34 of organization 14.

System 10 may include any number and type of art service providers 12 offering various art services 18. Each art service provider 12 represents any suitable collection of components capable of offering access to art 40 and art services 18 through defined services interfaces 24. Art service providers 12 offer machine readable services interfaces 24 that enable structured queries to access and interact with art 40 relating to art services 18. For example, a particular art service provider 12 may provide access to and interaction with a local art competition. As another example, a particular art service provider 12 may provide access to and interaction with an art uploading system that enables users to upload multiple digital media files containing at least a portion or representation of art available online. As another example, a particular art service provider 12 may provide access to and interaction with a media product for playback by one or more media players. An exemplary media product may provide access to multiple first media content modules operable to access media content items and may provide access to multiple subsets of second media content modules operable to access media content items. In operation, the exemplary media product accesses a subset of second media content modules based on input from a user into a decision module associated with the subset and/or a default decision selecting the subset by a processor executing decision logic using input from a user. To provide these functions, art service providers 12, potentially using art services agents 20, may support any number of features and interfaces to features. According to particular embodiments, art service providers 12 identify particular features and techniques for interfacing with those particular features of art services 18 using services interfaces 24. According to particular embodiments, art service providers 12 operate and advertise according to publicly developed and available standards for communications. System 10 contemplates that art service providers 12 may include any number and/or type of components, such as components for communication with art services agents 20, organization 14, and/or organization agents 22.

System 10 may include any number and type of art services 18. For example, system 10 may include art services 18 for creating, supplying and viewing art, payment, registration, login, account management, and other appropriate business services. Each feature within an art service 18 may provide any suitable level of sophistication. For example, a viewing feature may support sophisticated uploading and preview formats and processes using a large number of viewing criteria. As another example, a video uploading feature may require input of specified video content into a particular one of multiple video fields, such as a video content placeholder for specified video content among other video content. According to particular embodiments, art services 18 operate using publicly developed and available standards for digital media formats and communications, such as picture and video formats, and comply with governing laws, such as those governing copyright for original works of art or freedom of information. Various art services 18 may be standards driven, corporation driven, dynamically created or otherwise specified to support appropriate interactions between organizations 14, users of organization 14 and art services 18.

System 10 may include any number and/or type of organizations 14 that enable interaction with users of an online environment and other elements of system 10. Organization 14 represents any suitable combination and arrangement of components facilitating collection and storage of information, including various algorithms and instructions, relating to an online environment and operation of an online environment. Organization 14, potentially through one or more organization agents 22, collects and stores this information and operates an online environment using browser application 38 and a plurality of web pages hosted by and/or accessed through Web server 36.

Organization 14 supports discovery and interaction with art services 18 to investigate and achieve business functions 34 of organization 14. For example, organization 14 may identify a particular art service 18 for uploading video content and then interact with the particular art service 18 to negotiate or otherwise establish payment terms and/or conditions. Users of organization 14 may then link to art services 18 from various web pages of organization 14 and use the identified art service 18. For example, for video uploading, organization 14 may supply selected video content, user profiles, video uploading format and pricing information to enable art service 18 to fulfill payment processing. Within organization 14, organization agent 22 handles this dynamic discovery and interaction by interfacing with art service providers 12 and other elements of system 10. In addition to actively seeking art services 18 to fulfill business functions 34, organization 14 and/or organization agent 22 may advertise various aspects of business functions 34 and permit service providers 12 to generate new users and user accounts on behalf of or in conjunction with organization 14.

As illustrated, system 10 includes at least one web server 36 in communication with the Internet over communications network 16. For the purposes of illustration, the disclosed embodiment is adapted to be used with the Internet serving as the computer network. However, other embodiments may be adapted to be used with other forms of computer networks, such as an intranet, and/or mobile networks, according to communication standards such as 3G networks, 4G networks, etc. Web server 36 includes an applet therein which generates a graphical user interface which displays an identifier and a link to register with organization 14 using the identifier. Web server 36 may be any computer known to those skilled in the art including standard attachments and components thereof (for example, a disk drive, a hard drive, CD/DVD player and/or network server that communicates with a central processing unit and main memory, sound board, keyboard, mouse and/or printer). Web server 36 may include any number of task-oriented applications, such as web browser applications. Web server 36 utilizes the Internet as a communications backbone and allows information to be passed to the web browser. According to particular embodiments, Web server 36 may include a form handler to collect and process information submitted by a user through browser application 38. The host site may also include an application server for running an applet on the Internet that is displayed on the user's computer. An exemplary applet may be used to view, edit, collect and process flowcharts and computer instructions for handling the flowcharts 48 and media content art 40. Exemplary computer instructions may be content delivery schedules 46. As illustrated, system 10 includes media player 110 in communication with the Internet over communications network 16. Media player 110 may be any component adapted to stream, play or otherwise display media content 40. Media player 110 functions to access media content 40 from a web server 36, application server and/or local and/or remote memory for delivery of media content 40 for audio and/or visual presentation, for example, according to content delivery schedules 46.

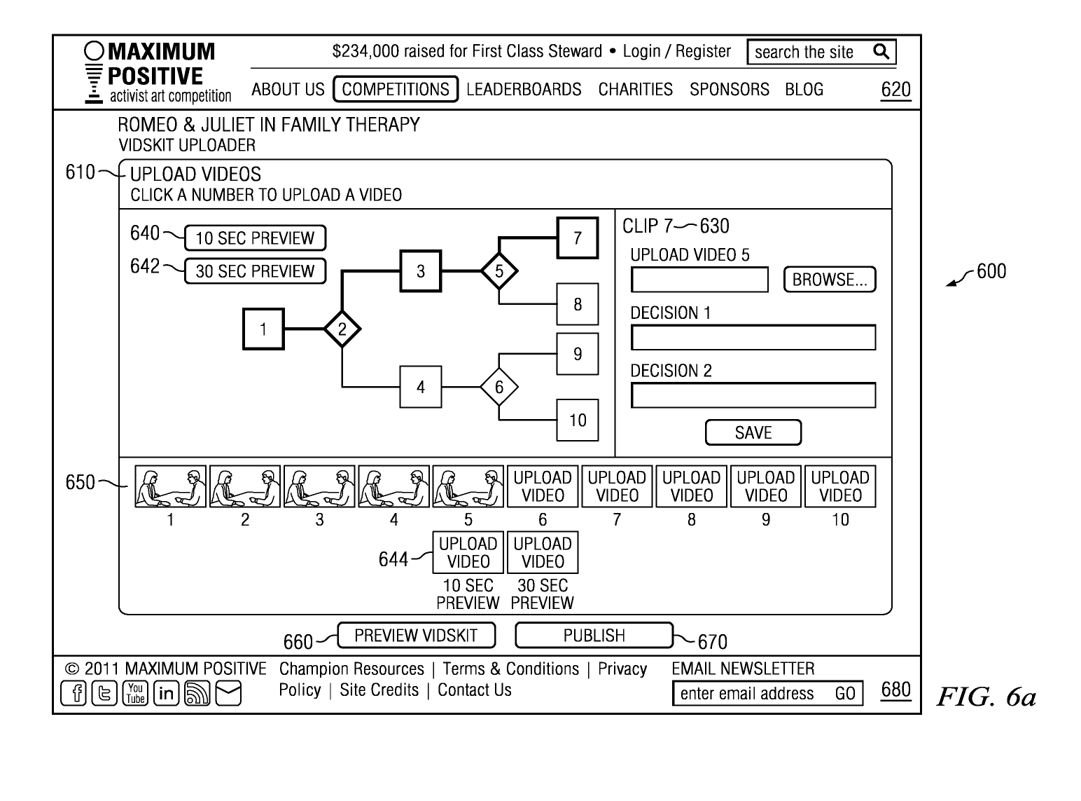

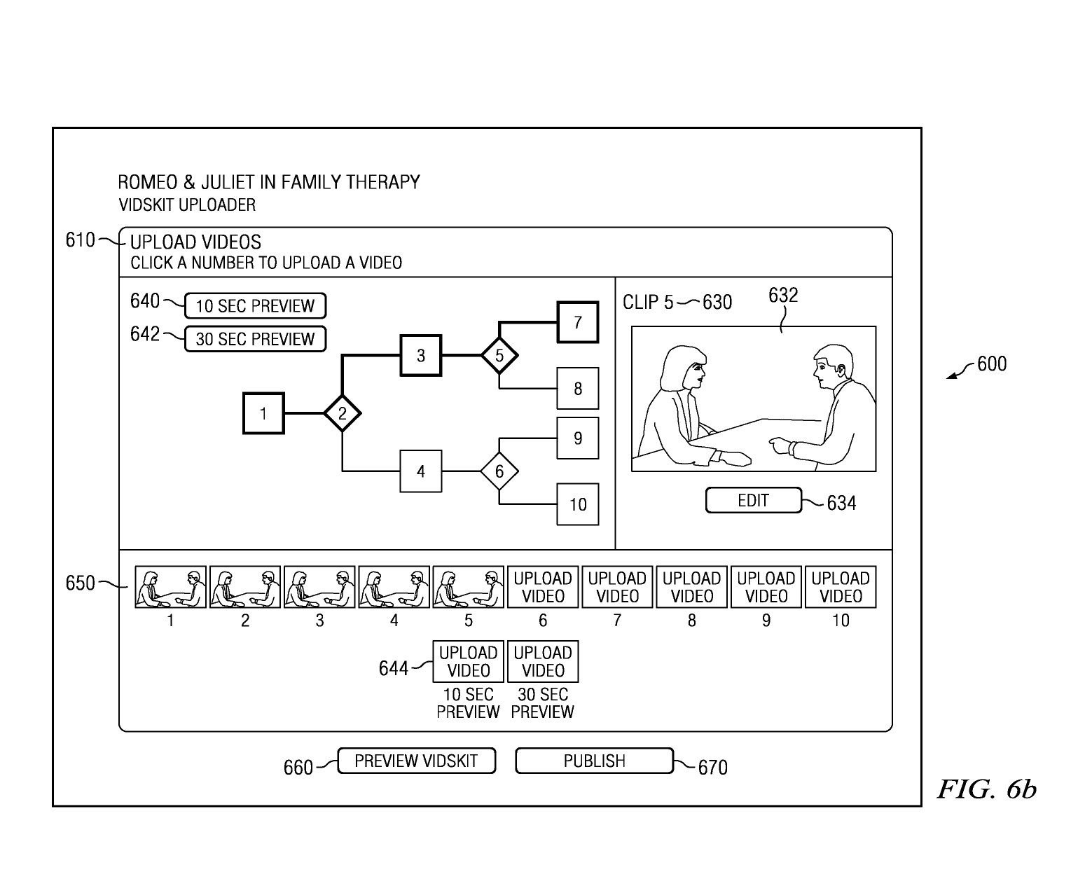

As illustrated in particular examples shown by FIGS. 6a-12a and described below, organization 14 may include a plurality of web pages for display on one or more websites, brochure sites, competition sites, shopping sites, sites for uploading and/or downloading information, merchandise sites, champion merchandising sites, feedback sites, blogs, etc. According to particular embodiments, brochure sites may include descriptions of charities, artists, other users, videos, facts, competition formats, competition listings, organization descriptions, accounting rules, video assets available to users, video uploading formats, celebrity panel preferences, champion pages, fan pages, etc. Competition-specific sites may reference, link to, and/or include social components, login pages, champion community pages, fan community pages, member pages for data entry and uploads, etc. Organization agents 22 and/or organization 14 may collect, store and/or share user feedback regarding competitions and various aspects of organization 14. The plurality of websites may include any number and/or type of e-commerce store modules, graphical art interface modules, and/or marketing modules. The plurality of websites may integrate search engine marketing and social networking techniques to drive sales and increase the conversion rate of a site.

The plurality of websites may include mobile websites to provide users and internal staff with an online experience that is equally usable on personal computers as well as mobile devices as users access data from many different platforms and on many different devices. The websites may be architected and optimized to perform on many different web browsers, including mobile browsers such as those found on an iPhone, iPad, BlackBerry, Android, and other devices. The websites may function using a plurality of instructions stored on a Web server and executed on a computer. The instructions may include any one or more computer code formats such as certified CSS/XHTML, DHTML, .NET development, PHP, mySQL, computer code that comply with W3C standards and/or any number and/or type of other code standards-based languages and utilities. Communication between Web server 36 and web browser application 38 may be achieved by any means using any methods including any computer languages generally now or in the future known in the art.

According to particular embodiments, organization agents 22 and/or organization 14 may manage content provided by the plurality of websites through any type of content management system of organization 14 or of service provider 12. Managing content may include editing photos, uploading videos, replacing headlines, modifying descriptions, modifying rules, managing views, managing rules, managing votes, managing other aspects of competitions, etc. In particular embodiments, content management system may be protected by any type of password protected entry and/or other security tools, including any number and/or type of security layers.

In operation, organization 14 communicates over communication network 16 with users of organization 14. System 10 contemplates any suitable number and/or type of users of organization 14, including champions 50, fans 60, charities 70, sponsors 80 and bracket makers 100 promoting art such as, for example, media content 40. Users of organization 14 may include organization 14 as one or more champions 50, fans 60, charities 70, sponsors 80 and bracket makers 100 promoting media content art 40. Users of organization 14 represent any one or more of individuals, corporations, commissioners, concierges, agents, brokers, friends, fans, sponsors, artists, organizations, and/or any other online user. Bracket makers 100 represent a particular type of champion 50. Bracket makers 100 function to modify flowcharts 48 that may be received by the content ranking engine and stored in a database. Flowcharts 48, including those modified flowcharts modified by bracket makers 100, may be presented, using a graphical user interface, to a user. According to particular embodiments, a graphical representation of the user modified flowchart may be presented to a user. According to particular embodiments, playback sequences of media content 40 are navigated by selecting and ordering modules of the flowchart, and at least a portion of the navigated playback sequences of the user modified flowchart may be delivered by the content ranking engine for playback.

Media content 40 may be provided by one or more content providers. Content providers represent any one or more of service providers 12, users 50-100, and/or organization 14. In operation, content providers and/or their agents such as, for example, champions 50, service providers 12, or organization 14, upload media content 40 to system 10. According to particular embodiments, a receiver of system 10 receives a plurality of bits of data from content providers and/or their agents. According to particular embodiments, a receiver of system 10 receives a plurality of instructions related to playback of a plurality of content items. According to particular embodiments, content providers and/or their agents such as, for example, champions 50 or organization 14 upload flowcharts 48 to system 10. Flowcharts 48 include modules operable to access media content 40 and media content items such as decisions, playback sequences of media content 40, default playback sequences, vidskit map, thumbnails associated with modules of flowcharts 48, sequences of images associated with modules of flowcharts 48, previews associated with playback sequences, flashback sequences of media content 40, graphical representations of playback sequences, ratings of media content 40, rankings of playback sequences, feedback ratings of at least a portion of playback sequences, winning playback sequences based on the highest ranking content, and the like. According to particular embodiments, one or more of service providers 12, users 50-100, and/or organization 14 may access such media content items using modules of flowcharts 48 and/or using services interfaces 24, interfaces 42 and/or browser application 38. According to particular embodiments, media content 40 may include advertising content and/or links to advertising content. According to particular embodiments, organization 14 may perform a number of steps to separate the content items from the instructions, such as, for example, including orthogonal frequency division multiplexing, associate each of one or more bits of content with the instructions related thereto. According to particular embodiments, media content items may include one or more bits of information for a decision, and the instructions may include one or more default decision instructions, wherein the default decision instructions are based on one or more current rankings of the playback sequences. According to particular embodiments, the instructions may be included on the website, and web browser application can execute the instructions and other requests of website content to web server 36. According to particular embodiments, the current rankings of the playback sequences are based on a plurality of media content ratings, the media content rankings based at least in part on a plurality of online activity. Online activity of a user represents input by the user and/or users associated with the user through the user's account from any of a keyboard, mouse, trackpad, remote control, and the like.

As illustrated in FIG. 1, organization agent 22 and/or organization 14 stores information relating to organization 14 and users of organization 14, such as user profiles 30, profile algorithms 32, descriptions 44, accounts 26, accounting rules 28 and business functions 34.

Business functions 34 include promoting artist successes and making charitable contributions within the context of competitions. Business functions 34 may include a range of allocation of revenues based on percentages. For example, one business function 34 of organization 14 may include allocating one-third of revenues to various artists who win art competitions, one-third of revenues to charitable contributions and the remainder of revenues to the organization 14. Business functions 34 may be profit driven, corporation driven, dynamically created or otherwise specified to support appropriate interactions between organizations 14, champions 50, fans 60, charities 70, sponsors 80 and bracket makers 100. Organization 14 achieves results from system 10 by exposing opportunities for artists and charities, maximizing creativity using a competition format, and leveraging local, regional and online social networks. According to particular embodiments, business functions 34 include one or more scoring algorithms. For example, one algorithm may calculate a score for an exemplary work of art 40 based on a number of views on a web page of the art 40. As another example, another algorithm may calculate a score for an exemplary work of art 40 based on quality as interpreted by various users of the organization 14. In this example, the quality score may represent an average of art quality ratings submitted by users on a scale, for example, of 1.0 to 12.5, for a given round of a competition. As another example, another algorithm may calculate a score for an exemplary work of art 40 based on the amount of money contributed through entry fees to a competition and/or credits spent by users to vote for the art 40. As another example, another algorithm may calculate a score for an exemplary work of art 40 based on feedback from fans 60 received prior to the competition and/or that round of the competition. As another example, another algorithm may calculate a score for an exemplary work of art 40 based on fan resonance from registered fans 60. According to particular embodiments, business functions 34 include feedback collection. For example, organization 14 may record numbers of views, shares, likes, time for viewing, repeated views, devices used for viewing, online activity of viewers, other online activity, and the like for purposes of rating media content 40. In this example, social networking systems may define groups of users for purposes of collecting group feedback and rating media content 40 based on feedback from groups of users. In operation, content ranking engine 16 may dynamically modify default selections and ordering of content for one or more users or groups of users based on ratings such as feedback ratings.

Descriptions 44 represents textual descriptions of organization 14 and may include textual descriptions of organization selected charities. Descriptions 44 may also include textual descriptions of a plurality of competitions in the past, present and future, and may include any number of audio and/or video components that describe the competitions, including pictorial images. Descriptions 44 may also include one or more formats for competitions. For example, a competition format may be a bracket competition, a free form competition, and/or any suitable competition having multiple rounds. Descriptions 44 may also include a plurality of double double tipping points, wherein each double double tipping point corresponds to a particular competition. Each double double tipping point includes an announcement date and a start date. For example, organization 14 may announce a competition on an announcement date and include in the announcements a specified number of champions and a specified number of fans that must register for the competition before the competition may begin. Once the specified number of champions and the specified number of fans are reached, the competition satisfies the double double tipping point and may begin. If a double double tipping point is not satisfied prior to the start date, the competition will begin on the start date. The higher the tipping point, the larger the bracket for the competition. For example, if a competition has 16 champions 50, the bracket for the competition may be similar to a sweet 16 bracket competition as seen in connection with NCAA college basketball tournaments.

In operation, accounts 26 may represent dollars or other actual currency, virtual currency such as credits or tokens, a specific relationship of virtual to actual currency or currency share, and/or any combination of actual and virtual currency. According to particular embodiments, in operation, actual or virtual currency is transferrable from one account 26 to another one or more accounts 26.

According to particular embodiments, accounts 26 represent virtual currency contributed by fans and/or sponsors in support of art 40. Accounts 26 include artist successes and charitable contributions to a cause for which an artist is passionate. Accounts 26 may also include sponsor accounts. For example, a sponsor account may include a matching percentage of user entry fees that a sponsor agrees to contribute for a particular competition and a match limit that defines the maximum amount contributed by a sponsor for a competition. Accounts 26 may also include scorekeeping criteria used to determine a winner.

According to particular embodiments, in operation, accounts 26 may be distributed by the organization using, for example, a payment widget as follows: charity 35% artist 35% champions 15% and organization 15%. The portion of an account 26 allocated to charities may be divided into one portion for the benefit of a champion selected charity and another portion for the benefit of an organization selected charity designated by an organization 14 to an organization selected charity selected by the organization 14 for a particular competition. For example, the portion of account 26 allocated to charities may be divided into 29.5% for the benefit of a champion selected charity and 5.5% for the benefit of an organization selected charity for a total of 35%. In this example, 85% of the charity portion benefits a champion selected charity and 15% of the charity portion benefits an organization selected charity. An organization may select and organization selected charity through organization agent 22.

According to particular embodiments, accounts 26 may be represented graphically using a payment widget associated with a particular user and apart from any given competition. Accounts 26 provide a profitable opportunity for artists such as video and music recording artists and a contribution opportunity for artists to raise money for cause about which they are passionate. Accounts 26 generate tips for artists and charities from their fans and sponsors. When champions 50 recruit fans and sponsors using their contacts and social networking channels like Facebook or Twitter to communicate with their contacts, champions 50 provide a link to their accounts 26. In this way accounts 26 of fans and sponsors are linked to artists and charities through champions 50.

A payment widget represents any suitable applet, widget, flash utility, java utility, and/or any compilation of code that may be executed by a personal computer or a mobile device in order to process a virtual payment to and/or from a virtual account. The payment widget communicates with organization 14 to transfer data collected by the payment widget to accounts 26 for purposes of maintaining accounts 26 in accordance with accounting algorithms. According to particular embodiments, accounts 26 may convert dollars using accounting rules 26 of organization 14 to tokens and/or any combination of tokens and dollars. For example, at the Texas State Fair, you buy tickets for cash and exchange the tickets for rides, food and merchandise.

According to particular embodiments, the techniques described herein for strategic management of entry fees to a particular competition and/or to register for a user account with the organization enable an organization to continuously and automatically generate artist successes and charitable contributions. For example, an organization may allocate a specific portion of entry fees of one user to another one or more users' accounts. The users may then use their accounts to acknowledge particular artists and particular charities. According to particular embodiments, when an amount of money is paid for a virtual account of a new user, a corresponding amount of money is added to the virtual account of a referring user where the referring user is linked to the new user during the registration process using a discount code associated with the referring user. According to particular embodiments, a referring user pays an amount of money to organization 14 upon registration or at a later time for discount code credits, and the referring user may receive a whole or partial reimbursement for a single one of the discount code credits upon payment by a new user of an entry fee to organization 14.

According to particular embodiments, accounting rules 28 may include recording, by a server for the online environment, a user profile comprising a user identifier. According to particular embodiments, profile algorithms 32 may include an algorithm to generate a link for associating a user identifier of a user for use by the user for recruiting one or more additional users by sending additional users the link.

Organization 14 keeps track of the number of views of the art 40 for purposes of ranking the art 40. This is a process often referred to as fan resonance or resonance. When a Website resonates, it can grow a very large audience very quickly. Resonance comes from normal human behavior. People tend to do two things when they find a Website they like: They tend to come back, and they tend to tell their friends. The retention and expansion of audience is resonance.

Organization 14 enables users to access art 40. Art 40 may include original content submitted to organization 14 by champions 50 over communication network 16 using interface 42. Art 40 may also include organizational art content originated and/or provided by organization 14. Organization 14 collects and stores art 40 and browser application 38 accesses this information over communications network 16 using Web server 36. Organization 14 may access some or all art for use in content ranking engine 16 to rank any ones of art 40. Art services 18 may access some or all art 40 for supplying, uploading and/or viewing art 40 for purposes of providing art services 18 to users of organization 14. Organization 14 may collect and store results of content ranking engine 16 and/or services 18 and use those results to create one or more profiles 30 according to profile algorithms 32. Organization 14 may debit and/or credit accounts 26 based on results of content ranking engine 16 according to accounting rules 28. Organization 14 may supply descriptions 44 to users through browser application 38. According to particular embodiments, organization agent 22 represents a division of organization 14 and offers entertainment marketing services. For example, each Champion 50 that registers may receive a plurality of business cards to help them promote their entry of art 40 within the context of an art competition. An artist may be his or her own agent and/or fan and may have single and/or multiple user accounts. Artists 90 and organizations 14 may jointly create art. Artist 90 and fan 60 may jointly create art. Artist 90 and champion 50 may jointly create art. In operation, various users may upload and modify content created by other users. For example, a user such as a celebrity may modify a particular scene of media content 40 by adding a character's presence within the scene using a video uploader and saving the modified scene into a database of media content 40 that is accessible by one or more users of the online environment.

Interface 42 provides a link between organization agent 22 and other entities within system 10. Depending upon the particular types of communications and configurations within system 10, interface 42 may include any suitable combination of hardware and/or logic for interacting with other components. For example, consider service 18 providing a payment processing service. In response to a query from organization agent 22, service 18 may supply details of features such as pricing, ordering, data input and other appropriate features. For example, organization agent 22 may access service 18 to determine the appropriate features interfaces 56 and then interact with service 18 to determine pricing. If the pricing meet established criteria, organization agent 22 may order the payment processing services and provide information for service 18 to perform payment processing functions. For example, organization agent 22 may supply various algorithms and instructions, such as pricing criteria, registration criteria, and fees and discounts.

Champion 50 represents a person or a team who selects a cause to champion, manages and enhances the art product created originated and/or submitted and promotes the art and a cause to the fan base. According to particular embodiments, champions 50 may earn money for their cause and for themselves throughout each competition. Champions can be talent agents, literary editors, band managers, film editors, disco jockeys, video jockeys, film producers, video producers, directors, etc. According to particular embodiments, champions 50 may create and/or contribute art for competitions and/or edit and/or promote art contributed by champions 50. For example, a first Champion 50 may create and contribute organizational content for a competition, and a second Champion 50 may edit and promote the organizational content contributed by the first Champion 50. Champions 50 may promote one or more artists and/or works of art 40. Champions 50 promote art 40 from start to finish within a competition format from one round to the next round to a final round. A winning artist for a given round of a competition represents an art 40 that is promoted to a next round of a competition based on results of content ranking engine 16.

Champions 50 may organize a team of artists to promote one or more works of art 40 of the team. Each team may represent a particular city or otherwise pre-approved geographical area. Each team may be selected by an area champion 50. Each team champion 50 may choose team members and management team. There may be a maximum of 20 core team members as follows team members maybe cross-functional. Teams, for example, may include a team of 20 members, such as, for example, four musicians, three film crew members, three videogame development team members, one classical artists such as a painter or sculptor, one corporate sponsor representative, one activist genius, one comedy troupe having three members, one member representing a charity, one web social networking genius, and one fashion designer.

Champions 50 may recruit fans 60. Champions 50 may receive referral fees when fan 60 and/or champions 50 register for a competition. Champions 50 may also receive referral fees when sponsors register for a competition. For example, when a sponsor registers for a competition, commits a sponsor match percentage up to a particular match limit of money, and pays an amount of money to organization 14 based on sponsor's 80 commitment, champion 50 who recruited sponsor 80 may receive a percentage of sponsorship amount such as 35% of amounts paid by sponsor 80. According to particular embodiments, champions 50 may receive referral fees by recruiting other champions 50. In this way, champions 50 recruit their own competitors and may receive not only referral fees by recruiting other champions 50, but also 35% of the other accounts 26 and at least a portion of any unused credits. A referral fee received by a champion 50 may be in the form of an actual or virtual account credit.

Fans 60 represent users of the organization 14 who support and evaluate art 40 by viewing the art, commenting in one or more online forums, and/or voting for the art. In a competition, when fans 60 view art 40, organization 14 keeps track of the number of views of the art 40 for purposes of ranking the art 40. In a competition, when fans 60 vote on art 40 using accounts 26, organization 14 keeps track of the number and/or amount of votes for the art 40 for purposes of ranking the art 40. According to particular embodiments, organization 14 may also utilize art quality scores to rank the art 40. Fans 60 may submit an art quality score, for example, using a sliding scale for art quality on a scale from 0 to 12.5, with 12.5 being the highest possible score for art quality.

Fans 60 interact in social media networks, virtual environments implemented by computer networks and other interactive media such as interactive television, local media and other local networks for social and business networking purposes locally, regionally, nationally and internationally. Sponsors 80 advertise products and brands to various individual and organizational users and promoters of social media networks, virtual environments implemented by computer networks and other interactive media such as interactive television, local media and other local networks. Such advertisements are typically distributed to social media network users using user location information, user web history and user preferences such as product purchase information. Users of social media networks may also advertise likes and/or dislikes, opinions, products and brands to the public and/or to all or selected groups or selected ones of their friends and/or fans within the social media network for purposes of gaining attention and support from their social media network connections and gaining new social media network connections. Users of social media networks may be incentivized to advertise to their friends in return for rewards such as coupons, status advantages within the social media network, real money and/or virtual money. Sponsors 80 may represent advertisers desiring to collect data regarding consumer preferences.

Sponsors 80 represent businesses that sponsor competitions, champions 50, and art 40 by matching accounts 26 at a certain percentage match up to a limited amount. Accounts 26 of sponsors 80 are linked to the champions 50 that recruit them. In this way, accounts 26 of sponsors 80, i.e. sponsorships, directly benefit champions 50 through a 15% referral fee. Organization 14 may generate profiles 34 sponsors 80 according to profile algorithms 32. Sponsors 80 receive recognition on a profile webpage dedicated to them that displays their profiles 34. Sponsors 80 also receive brand recognition on web pages promoting particular competitions. Sponsors 80 received more brand recognition when the champions 50 that recruit them advance in the competition. Sponsors 80 are able to offer discounts, promotions and other benefits to fans 60 using any number of promotional codes and may measure their charitable impact by counting each instance in which the promotional codes are used. In this way, organization 14 provides sponsors unparalleled value with authentic brand name and goodwill creation.

According to particular embodiments, at least some users participate in art competitions via computer input by a computer, which may include desktop or laptop computers having a modem to connect with the network 16 for communication purposes using a web server. System 10 may optionally include stand-alone units capable of printing credits in the form of tickets, coupons, magnetically readable cards, cards with barcodes, or any other type of “smart” card which may be redeemable at the site of a competition. Input within a competition may include voting and/or other user participation in any suitable number and/or type of competition format or other environment to promote artists. According to particular embodiments, competitions may include online art creation in various mediums of art 40. According to particular embodiments, virtual art competitions mirror local art competitions online for worldwide viewing.

Therefore, as provided by this illustration, organization 14 may include both functional aspects, such as content ranking engine 16 and feature interfaces 42, and data aspects, such as descriptions 44. However, while illustrated as including specific elements arranged in a particular configuration, system 10 contemplates services 18 including any suitable combination arrangement and elements for providing network accessible services. Thus, system 10 contemplates services 18 including any suitable combination of hardware and/or logic and the functionalities of services 18 being incorporated in and/or provided by any suitable network accessible equipment.

The illustration provided and the preceeding description present generic elements for implementing a system to enable automated, agent-based interaction between an organization and any number of champions 50, fans 60, charities 70, sponsors 80 and bracket makers 100. However, while the embodiment illustrated includes specific components arranged in specific ways, it should be understood that this illustration, accompanying description, and all examples given are provided only to aid in clarifying the basic concepts of these techniques and none of these are intended to limit the scope of these concepts.

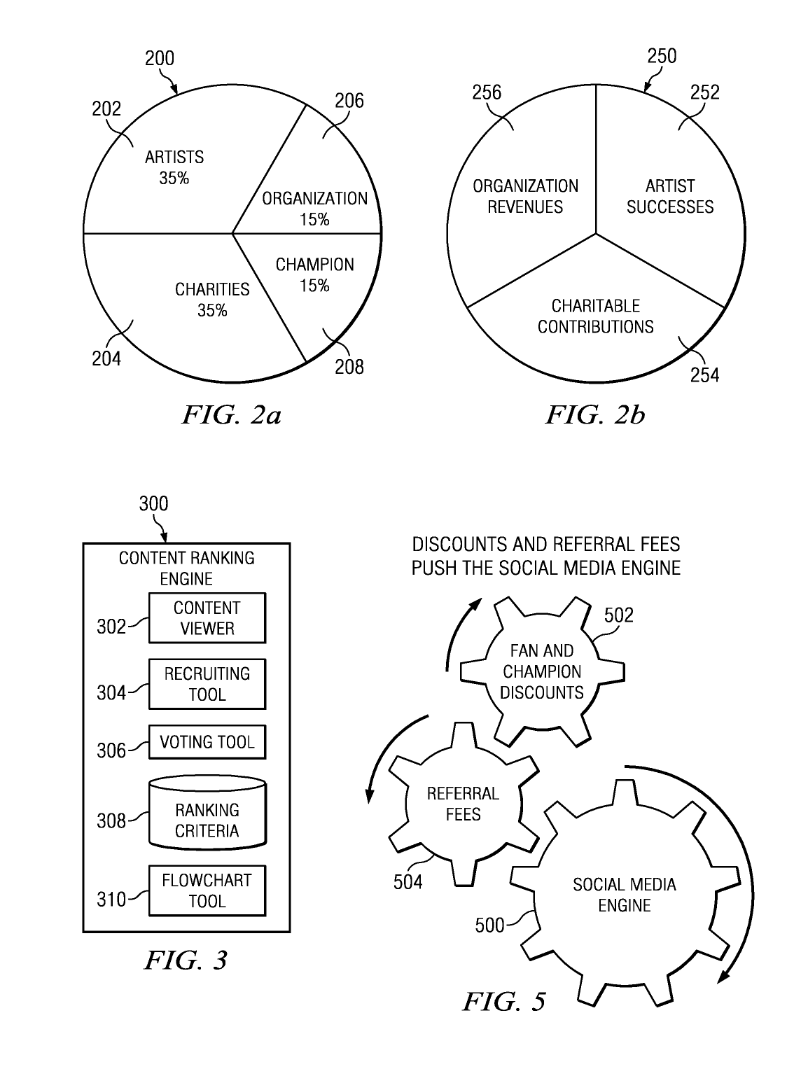

FIG. 2a is a pie chart 200 illustrating business function 200. According to particular embodiments, business function 200 may include distributing revenues of the organization to promote artist successes and make charitable contributions within the context of competitions such that the organization, artists and charities share in the revenues of particular competitions approximately equally. According to particular embodiments, business functions 34 may include a range of allocation of revenues based on percentages for any given one or more or all competitions hosted by the organization. In exemplary embodiments, business functions 34 of organization 14 may include allocating one-third of all entry fees to a particular competition to the artist who wins the competitions, one-third of all entry fees to the particular competition to charitable contributions to one charity selected by the organization and to a second charity selected by the artist who wins the competition (i.e. the “winning artist”), one-sixth of all entry fees to the particular competition to the champion who wins the competition (i.e. the “winning champion”), and the remainder of all entry fees to the particular competition to the organization 14. Business functions 34 may be profit driven, corporation driven, dynamically created or otherwise specified to support organizations 14, champions 50, fans 60, charities 70, sponsors 80 and bracket makers 100. Business functions 34 function to define the results that an organization 14 may achieve for artists and charities from an online gaming environment as illustrated, for example, by system 10. According to particular embodiments, business functions 34 may define a competition format for maximizing the creativity of various artists for creating art 40. According to particular embodiments, business functions 34 may include leveraging one or more local, regional and/or online social networking connections.

FIG. 2b is a pie chart illustrating distribution of combined entry fee 250. In general, the sum of the components of the combined entry fee 250 provides enough support to an organization to sustain its existence and/or prosperity while maintaining its goals to generate artist successes and charitable contributions. The combined entry fee 250 includes a virtual account deposit, a referral fee and/or a discount and a maintenance fee. As illustrated, distribution of a combined entry fee 250 is egalitarian as between the organization revenues, artist successes, and charitable contributions. While not illustrated, the combined entry fee 250 may also include any other suitable components to provide enough support to an organization to sustain its prosperity while fulfilling its purpose to generate artist successes and charitable contributions.

Processing a combined entry fee 250 may include allocating the entry fee into a plurality of organizational revenues 256, a plurality of artist successes 252, and a plurality of charitable contributions 254 according to allocation instructions such that the organization sustains its prosperity while fulfilling its purpose. Allocation instructions may depend upon organizational objectives. Examples of organizational objectives include artist successes and charitable contributions. In this way, organization 14 may promote artists by paying artists at least a portion of accounts receivable in an online environment.

FIG. 3 will be described below both generically and specifically with respect to particular types of elements and operations. FIG. 3 illustrates content ranking engine 300. Content ranking engine 300 includes content viewer 302, recruiting tool 304, voting tool 306, ranking criteria 308 and flowchart tool 310. In some embodiments, content ranking engine 300 determines a winning user according to one or more ranking criteria. In other embodiments, content ranking engine 300 determines a default playback sequence according to one or more ranking criteria. In particular embodiments, content ranking engine 300 may utilize ranking criteria 308 in conjunction with traditional research and measurements including quantitative and qualitative market research, online media tracking, website analytics, sales data, public relations data, advertising data, investor relations information, brand management analysis, brand impact analysis, product research information, and product development information. Content viewer 302 represents graphical components used by a web browser or other content interface to display ratings, rankings and other media content items associated with media content 40, such as those items based upon social networking systems. For example, content viewer 302 may display art quality viewer, highlighted playback sequences on a vidskit map, art quality index, fan resonance index, acknowlebeaution index, likes, tweets, number of views, “SHARE” functions, sponsorship information, comment information, inputs and outputs of a media player, user account and/or profile information relating to additional viewer components, etc. Recruiting tool 304 represents a software module in communication with one or more social networking systems and/or contact databases to advertise media content such as playback sequences. In operation, recruiting tool 304 functions to recruit fans of the online environment and content providers of media content to the online environment. According to particular embodiments, content ranking engine 300 monitors recruiting tool 304 to rate content based on online activity of users collected by recruiting tool 304. Voting tool 306 may be used to count votes and categorize votes based on ranking criteria 308. For example, votes are generated through online activity such as acknowlebeautions and may be counted individually or according to acknowlebeaution amounts. According to particular embodiments, votes are counted by voting tool 306, for example, when a user submits an art quality score. In this example, voting tool 306 may summarize art quality scores submitted by users for a current total score. Ranking criteria 308 may include an algorithm for summarizing art quality scores. For example, an exemplary algorithm may use one or more users' account information such as acknowlebeaution amounts by a user and/or associated user accounts to determine the art quality score to display to the user. Flowchart tool 310 represents navigation tools for modifying flowcharts and/or presentation tools for presenting media content modules, playback sequences and previews of media content and graphical representations of media content modules, playback sequences and previews of media content. In operation, flowchart tool 310 may function to present flowcharts, including media content modules, navigation tools, decision modules, and playback sequences contained therein.

FIG. 4 illustrates an exemplary flowchart 400 that displays the available situations, decisions, conclusions, and their interrelations that form one or more playback sequences. Flowchart 400 includes situations 402, 410, and 412, which are connected to decisions 404, 414, and 416, respectively. Decision 404 is connected to situations 410 and 412, decision 414 is connected to conclusions 418 and 420, and decision 416 is connected to conclusions 422 and 424.

According to particular embodiments, each situation includes at least a portion of video content that can be played back to users. Each situation is also connected to a respective decision or conclusion. Each decision may have an associated default that can be used to determine which subsequent situation or conclusion is part of a playback sequence. A playback sequence comprises a plurality of situations and a conclusion. As illustrated in exemplary flowchart 400, there are four possible playback sequences. For example, situation 402, 410 and 418; 402, 410 and 420; 402, 412 and 422; 402, 412 and 424. According to particular embodiments, a playback sequence may include some or all of one or more playback sequences. One or more playback sequences may be identified by selecting one or more media content modules and/or one or more decision modules and/or one or more other portions of the flowchart. According to particular embodiments, a content provider may select default playback sequences for a given flowchart. For example, the default playback sequence at a given time may be situation 402, situation 410, and situation 418.

According to particular embodiments, flowchart 400 may be displayed by a content playback device. A user of the playback device can use the appropriate input apparatus and methods of the content playback device to select one or more of the situations or conclusions. Selecting one of the situations or conclusions initiates a playback sequence that is related to the selection. The playback sequence that is related to the selection may also include default selections. As an example, situation 410 may be selected where conclusion 418 is the default conclusion of decision 414. In this example, the playback sequence will include situations 402 and 410 and also include the default conclusion 418 of decision 414.

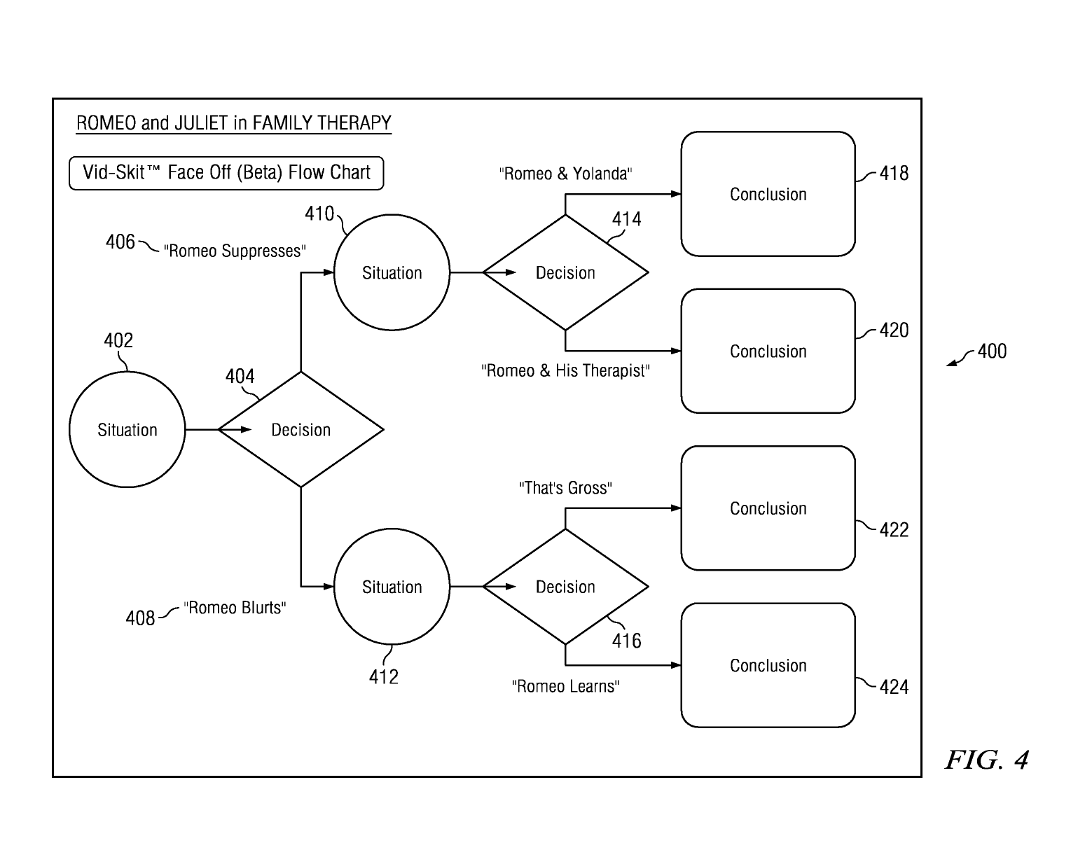

FIG. 5 illustrates a functional diagram showing the relationship between the function of sharing social networking connections of users by accessing one or more social media engines to the purpose of generating artist successes and charitable contributions in an online environment. As illustrated, according to particular embodiments, organization 14 utilizes referral fees 504 and fan and champion discounts 502 to leverage various social networking connections of users that the organization 14 may access using social media engine 500. Social media engine 500 may represent a social networking system and/or a contact management system. The various operations shown in the functional diagram of FIG. 5 include pushing to social media engine 500 using referral fees 504 and fan and champion discounts 502.

According to particular embodiments, fan and champion discounts 502 may be redeemed by debiting a virtual credit account of a first user in an amount equal to a discount amount off of the purchase price of an entry fee paid using a second user account. In operation, an organization 14 may receive results of a processor upon processing a discount 502 associated with a first user redeemed during registration of a second user. For example, the second user may communicate the discount 502 of a first user using a graphical user interface accessed by the second user's computer over a communication network during account registration.

According to particular embodiments, referral fees 504 represent amounts paid into a first user's account when a second user recruited by the first user or a recipient of the benefits of a first user's account registers for an account. For example, an exemplary referral fee 504 may be paid to a first user when, after one or more rounds of a competition, a number of unused second-user discounts 502 are automatically deducted from the second user account and that number of first-user discounts 502 are automatically added to the first user account. According to particular embodiments, a referral fee 504 may be paid to a first user or a third user receiving the benefits of referral from a first user's account. As another example, an exemplary referral fee may be paid to a first user when, after one or more rounds of a competition, a number of unused second-user virtual credits are automatically deducted from the second user account and that number of first-user virtual credits is automatically added to the first user account. According to particular embodiments, a referral fee 504 may be paid to a first user or a third user receiving the benefits of referral from a first user's account.

FIGS. 6a and 6b illustrate user interfaces for presenting media content in a flowchart format. FIG. 6a illustrates a website accessed using a browser application as shown in browser window 600 that is operable to upload video content that may be associated with the situations or conclusions of flowcharts. As illustrated, browser window 600 includes a header 620, a footer 680, and a vidskit uploader 610. According to particular embodiments, organization 14 operates the website and may incorporate any number of services by service providers into its operation, such as, for example, video hosting services. Vidskit uploader 610 indicates that the title of the vidskit in vidskit uploader 610 is “Romeo and Juliet and Family Therapy.”

As illustrated, vidskit uploader 610 includes an upload videos portion 650, a portion displaying a flowchart of the vidskit, a detailed upload video module 630 for selecting media content for a media content module and/or decision module, uploading the media content, associating the media content with at least one playback sequence of the flowchart, and/or saving the media content, a preview vidskit button 660, and a publish button 670. The preview vidskit button 660 allows a user to preview the current vidskit. The publish button 670 allows the user to publish the vidskit. Vidskit uploader 610 allows a user to upload videos, preview videos, preview vidskit and publish vidskit. The upload videos portion 650 includes numbered upload video modules 1-10 and upload video preview modules 644. The upload videos portion 650 includes upload video modules displaying thumbnails or other representative images or sequences of images of videos as placeholders for videos that have already been uploaded (for e.g., videos 1-5) and upload video modules for which additional videos may be uploaded (“UPLOAD VIDEO” 6-10). The upload videos portion 650 functions to present representations of videos that have already been uploaded by one or more users, associate the videos with the flowchart, and enable videos to be uploaded. The portion displaying the flowchart of the vidskit includes a ten second preview button 640, a thirty second preview button 642, and the flowchart. The ten second preview button 640 functions to initiate a preview of the playback sequence that is currently associated with a selected situation or conclusion of the flowchart. The thirty second preview button 642 initiates a preview of the playback sequence that is associated with a selected situation or conclusion of the flowchart.

The flowchart is interactively displayed so that a user may select elements of the flowchart. As illustrated, the flowchart includes situations 1, 3, and 4; decisions 2, 5, and 6; and conclusions 7, 8, 9, and 10. According to particular embodiments, cursor rollover selecting the various displayed elements of the flowchart causes other portions of the flowchart, including portions displayed and/or not displayed, to become highlighted. As an example, if situation 3 is rolled over and/or selected, then video 3 in the portion 650 is highlighted. According to particular embodiments, other portions may also be context sensitive. As another example, if video 5 in the portion 650 is rolled over and/or selected, then the portion 630 enables the user to select a video for video 5, which may include any media content including advertisements and images, sequences of images, and/or previews of media content, text for Decision 1 and text for Decision 2.

The portion 630 for selecting a video to upload and associating that video to the flowchart includes an indication (entitled here as “CLIP 7”) that identifies the element of the flowchart that is selected; an indication (entitled here as “UPLOAD VIDEO 5”) edit box, and browse button for uploading a video; indications (entitled here “DECISION 1” and “DECISION 2”) and edit boxes for setting the title of the portion of the playback sequence following a decision or the text to be displayed upon playback of the decision; and a SAVE button for saving any changes made related to the flowchart. In operation, the portion 630 is operable to upload multiple videos associated with a flowchart. The flowchart functions to order the videos into multiple playback sequences and present playback sequences to a user. According to particular embodiments, users may select a playback starting point using a pointing device or other navigation tool to view playback of video. According to particular embodiments, a playback sequence

The UPLOAD VIDEO 5 indication, edit box, and browse button provide for the ability for a user to upload video related to the element of the flowchart selected. The edit box and browse button may be disabled to a user when there is no part of the flowchart selected to which a video can be associated. For example, if the flowchart decision 5 is selected and videos cannot be associated with decisions of the flowchart, then the edit box and browse button next to the UPLOAD VIDEO 5 indication may be disabled.

According to particular embodiments, the UPLOAD VIDEO 5 indication can be context sensitive to the number video that is selected in the portion 650. For example, if video 4 of portion 650 is selected, then the indication may state “UPLOAD VIDEO 4.” The indications “DECISION 1” and “DECISION 2” and their respective edit boxes are operable to enable a user select the interface text of a decision of the flowchart. Additional indications and edit boxes may represent decisions allowing for more than two options. According to particular embodiments, the text of an edit box may default to any type of metadata associated with a video that is uploaded. For example, if a video is uploaded for flowchart element 7, the file name of the video or text within the video file itself, such as the title, may become the default text for one of the decision edit boxes of flowchart decision 5.

The portion 650 displays videos that have already been uploaded (videos 1-5) and spots where additional videos may be uploaded (“UPLOAD VIDEO” 6-10). As discussed above, portion 650 may be context sensitive to other portions that are displayed and the other portions may be context sensitive to the selections of portion 650.

FIG. 6b illustrates a standalone software application window 600 that displays vidskit uploader 610 similar to that shown in FIG. 6a. Portion 630 includes a media player for viewing the uploaded videos, as shown by video window 632, and EDIT button 634. According to particular embodiments, portion 630 may include EDIT button 634 as an edit media content service interface to an edit media content service and/or application. Buttons 640 or 642 function to activate the media player for viewing previews uploaded in modules 644. The video window 632 allows for the user to see a preview of the video and the EDIT button 634 switches portion 630 back to displaying controls for uploading and associating videos with the flowchart, as illustrated in FIG. 6a.

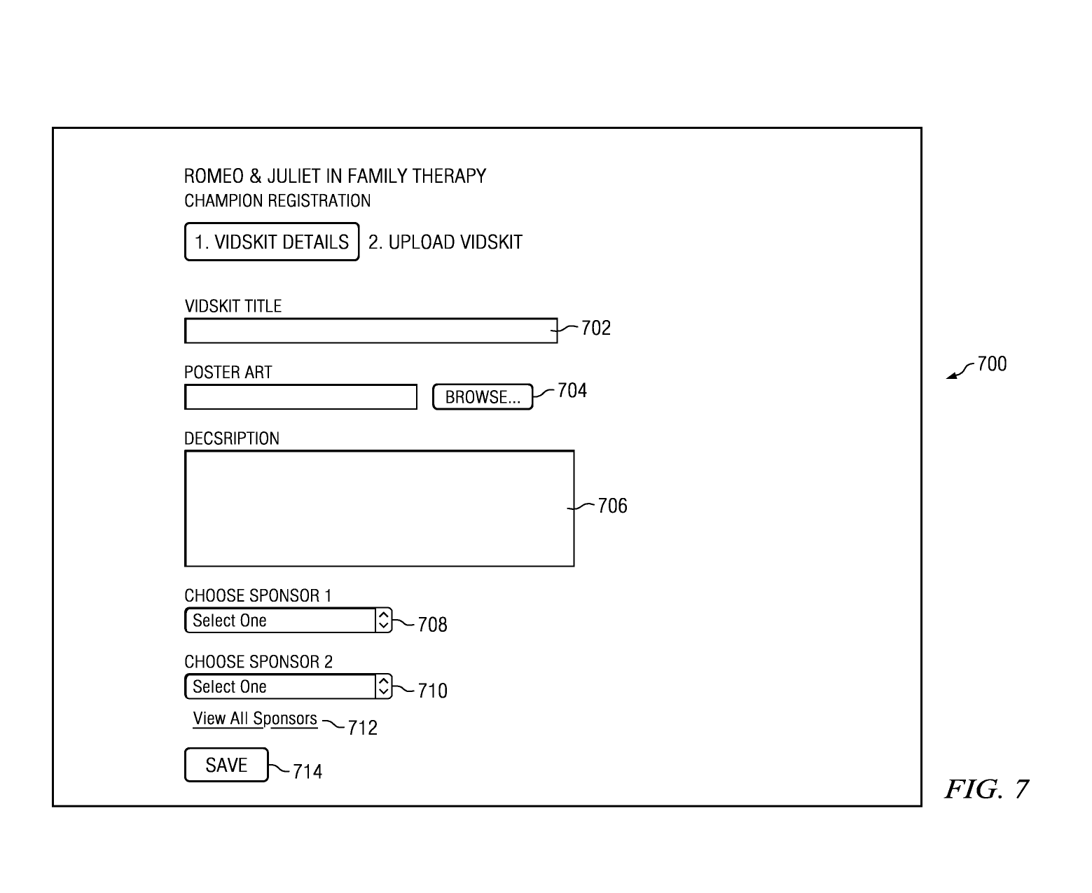

FIG. 7 illustrates a registration display 700 that is shown to a user for registering a vidskit. Registration display 700 includes an information portion, a details portion, and a save button 714. The information portion includes a vidskit indication (entitled here as “ROMEO & JULIET IN FAMILY THERAPY”); a purpose indication (entitled here as “CHAMPION REGISTRATION”); a progression indication shown with two steps (entitled here as “1. VIDSKIT DETAILS” and “2. UPLOAD VIDSKIT”). The vidskit indication displays the title of the vidskit for which a champion or other user is registering. The purpose indication displays the purpose of the form so that a user knows the entry for which entered information applies. The progression indication shows how many steps are required for the registration process and indicates which step is currently active. As displayed, the initial step is active and, in this step, a user enters the details of the vidskit. The SAVE button 714 saves any details that have been entered according to logic programmed for completion of the step and enables a user to proceed to the next step of the registration process. As shown in FIG. 7, the next step of the process is to upload the vidskit for which the details have been entered.

The details portion includes a vidskit title indication and edit box 702; a poster art indication, edit box, and browse button 704; a description indication and edit box 706, and a sponsor selection portion. A champion enters the name of the vidskit title into edit box 702. The champion may also associate poster art to the vidskit using edit box and browse button 704. Such poster art may be of any type or form of image file, including JPEG, PNG, GIFF, TIFF, and so forth. The champion enters a description of the vidskit into the edit box 76.

The sponsor selection portion includes a first sponsor indication and drop down list 708; a second sponsor indication and drop down list 710; and a view all sponsors link 712. The first sponsor drop down list 708 allows the champion filling out the registration form to associate a first sponsor to the vidskit. The second sponsor drop down list 710 allows the champion two associate a second sponsor to the vidskit. Additional sponsor indications and drop down lists may be added to the display and this addition maybe in response to a selection of the first to second sponsor. When activated, the view all sponsors link 712 provides for the display of all sponsors available to be associated with the vidskit.

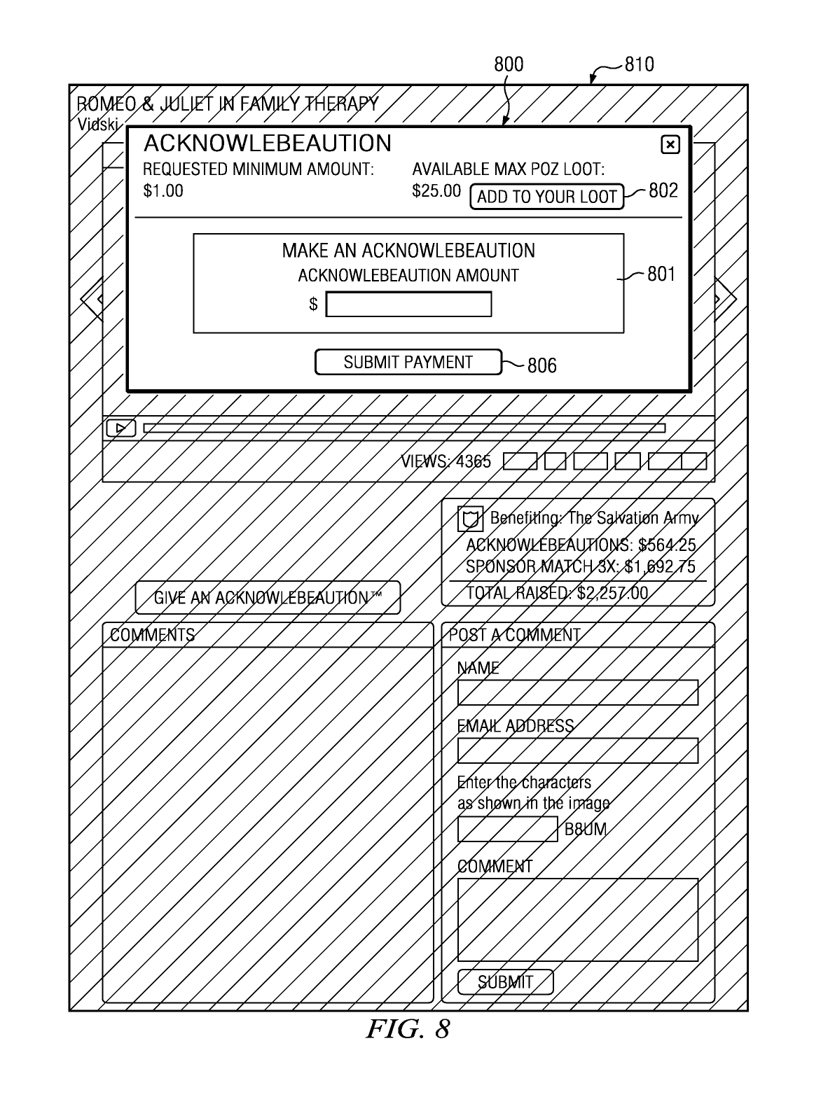

FIG. 8 illustrates an acknowlebeaution form 800 that allows a user to make an acknowlebeaution. The acknowlebeaution form 800 includes form information, an ADD TO YOUR LOOT button 802, a form close button, an amount portion 801, and a SUBMIT PAYMENT button 806. According to particular embodiments, activation of acknowlebeaution form 800 causes other portions of browser window such as display 810 to fade and/or, in some instances, to become inactive to the user, for example, for security purposes. The form close button allows a user to close the acknowlebeaution form 800.

The form information includes a name indication (entitled here as “ACKNOWLEBEAUTION”), a requested minimum amount, and a maximum available amount of a user's account that the user may acknowlebeaute to the vidskit (illustrated here as “MAX POZ LOOT”). As shown in FIG. 8, the minimal requested amount is $1.00 and the maximum available amount is $25.00. A user viewing this form can increase their account balance (whether or not that changes the available Max Poz Loot for this acknowlebeaution) by clicking on the ADD TO YOUR LOOT button 802, which will take the user to another form for adding money to the user's account.

As illustrated, the amount portion includes an amount information indication and an amount edit box. While not illustrated, the amount portion may include any programmed logic for an organization's accounting rules for acknowlebeautions. The amount information indication informs the user of the purpose of the edit box. The purpose here is for the user to make an acknowlebeaution of the amount specified in the edit box. The amount in the edit box should be between the requested minimum amount and the maximum available amount. Determining whether the amount in the edit box is between the minimum and maximum can be done dynamically as an amount is typed in or as the select payment button 806 is hovered over and/or selected. According to particular embodiments, the edit box may be pre-populated with the requested minimum amount, the maximum available amount, or any other amount such as, for example, an amount based upon one or both of the requested minimum amount and the maximum available amount.

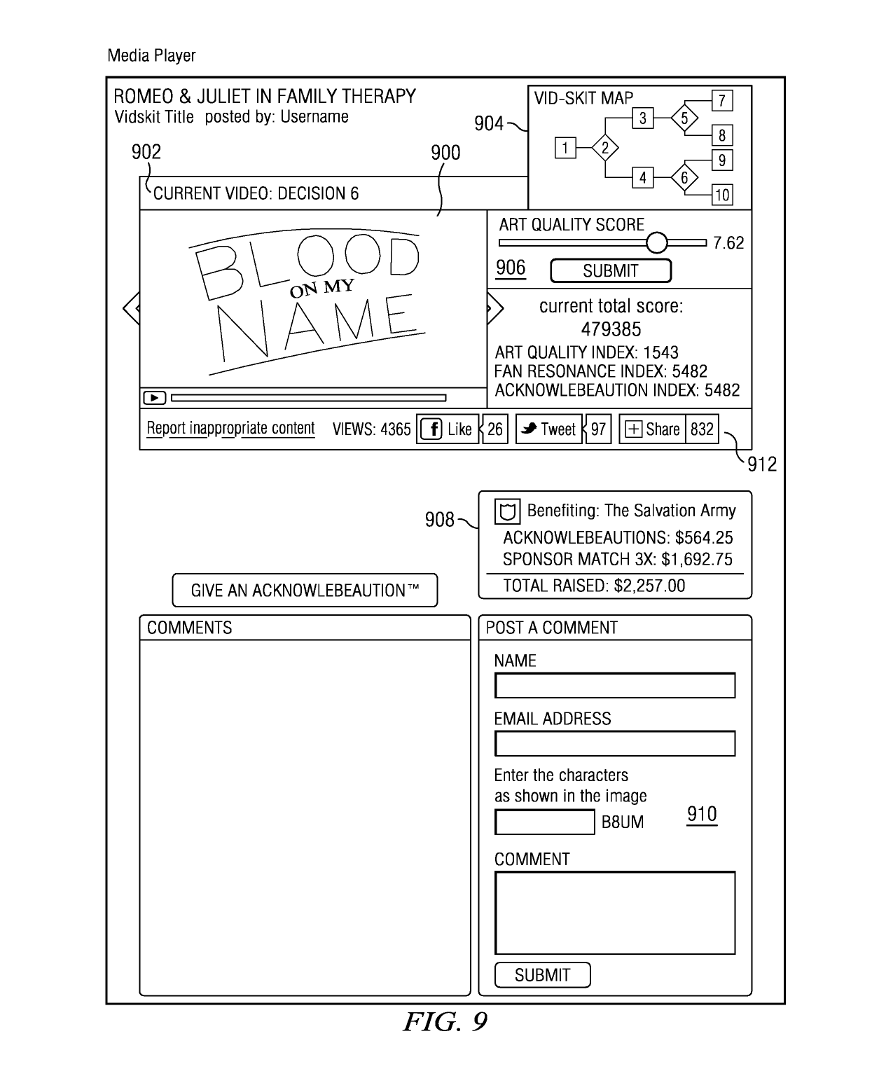

FIG. 9 illustrates a display on a user device for viewing a vidskit. According to particular embodiments, the user device may be the browser of a computer, smart phone, smart television or standalone application (such as a media player) on the computer, smart phone, smart television or any device in between the communications network and a display. The description of FIG. 9 describes a display in the context of a media player on a computer, but other suitable environments may be used in accordance with particular embodiments. The media player presents the vidskit including one or more of the following portions: an information portion, a vidskit map portion 904, a current video portion 902, a score portion, a sharing portion 912, a benefits portion 908, an acknowlebeaution portion, a comment view portion, and a comment submit portion 910. The information portion includes the title of the vidskit. According to particular embodiments, the information portion also includes a user name of the champion associated with the vidskit.

The vidskit map portion includes a title and a flowchart of the vidskit. The title identifies to the user that this portion is a vidskit map. The flowchart is the flowchart used to create the playback sequences of the vidskit. The flowchart may indicate the entire sequence of situations, decisions and conclusions that are included in the current playback sequence. According to particular embodiments, during playback of the playback sequence, the vidskit map may individually highlight any of the situations, decisions, and conclusions that are currently being viewed in the media player.

According to particular embodiments, when a user clicks the various elements of the flowchart of the vidskit map, the current playback sequence may change, the current video content may change, and/or the score portion may change, among other things. As an example, a user clicks on a situation that is not part of a current playback sequence and the currently displayed video is still a part of the new playback sequence. In this example, the media player may select the new playback sequence while continuing to display the current Video content as this current video content is a part of the new playback sequence. As another example, the user clicks on a situation that is not part of a current playback sequence and the current display video is also not a part of the new playback sequence. In this case, the media player can select the new playback sequence and may restart the video content with the video content associated with the situation selected by the user. As another example, the playback sequence and the video content playback are unchanged and the scoring portion changes. In this example, the user may view the scores, ratings and rankings of the various situations, decisions, conclusions, and playback sequences associated with the vidskit.

The current video portion includes information 902 and video playback display 900. Information 902 states the name of the element on the flowchart that is associated with the video content that is currently playing. As illustrated, the current video is that of flowchart decision 6. The playback display 900 shows the actual video and video control buttons. The video control buttons include a play button and a video slider that indicates any of length of video content, the current position of the playback of the video content, length of the playback sequence, the current position within the playback sequence, and the like.

The score portion includes a score submission portion 906 and a score viewing portion. The score submission portion 906 includes type information, a score a metric, a selector for the score metric, and a SUBMIT button. As illustrated, the type information is that of an art quality score, the score metric is 7.62, and the selector is a slider that allows for picking an art quality score of between 1 and 10 in 0.01 increments. Using the SUBMIT button, the art quality score that is currently selected can be associated with any of the vidskit, the current playback sequence, the current element of the flowchart, and the like. The score viewing portion may display any number of scores related to the vidskit. As illustrated in FIG. 9, the vidskit has a current total score of 479385, an art quality index of 1543, a fan resonance index of 5482, and an acknowlebeaution index of 5482. The display of the scores within the score viewing portion may be dynamically updated as multiple users submit their scores, acknowlebeautions, and the like. The scores illustrated may be cumulative scores, average scores, a combination thereof, etc.

The sharing portion includes a link to report inappropriate content, a view counter, and any number of links 912 to associate the vidskit with other websites, including social networking systems and contacts applications. As illustrated, the current vidskit has 4365 views and the links 912 allow for increasing the vidskit's 26 Facebook likes, 97 Tweets, and 832 shares.

The benefits portion 908 includes information and amounts related to the money associated with the vidskit. As illustrated, the vidskit benefits the Salvation Army and has acknowlebeautions in the mount of the $564.25. The vidskit also has at least one sponsor providing for a 3X match totaling $1,692.75. The total raised for this vidskit is $2,257.00. All of the data in the benefits portion 908 can be dynamically updated to accurately reflect the current acknowlebeaution amounts, sponsor matches, and total amounts raised for the vidskit or any portion thereof. The acknowlebeaution portion includes a GIVE AN ACKNOWLEBEAUTION button. The GIVE AN ACKNOWLEBEAUTION button, when selected, calls a pop up window of a form for giving an acknowlebeaution such as, for example, the form illustrated in FIG. 8.

The comment view portion includes a title indicating the purpose of this section within the display of the media player and a display portion displaying all the comments that have been associated with any part of the vidskit. The comments that are displayed may change as new comments are added and may also change as different elements of the flowchart are viewed in the media player. For example, when the user selects the beginning of a playback sequence for viewing, comments may be displayed that relate to situation 1, and after decision 2 leads to situation 3, comments may be displayed that relate to situation 3.

The comment submit portion 910 includes the title indicating the purpose of the section, a name edit box, an email address edit box, the security code edit box, the comment edit box, and a submit button. A user may enter their name, email address, security code and comment into the appropriate edit boxes and then activate the submit button to have the comment associated with the vidskit. The comment may be associated with the vidskit as a whole or to any portion thereof, including individual playback sequences, individual elements of the flowchart, and the like.

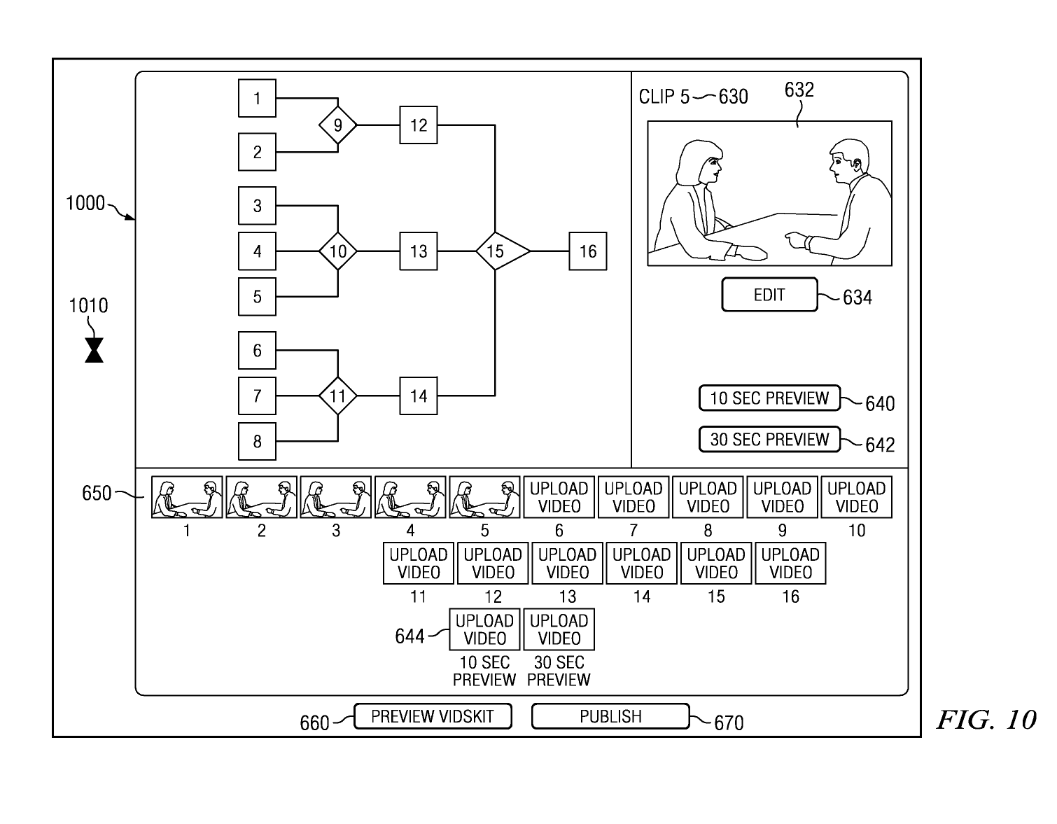

FIG. 10 illustrates an exemplary media content viewer for use in modifying an exemplary flowchart FIG. 10 illustrates window 1000, which includes a flowchart display area and a media display area 630, which includes a media content viewer 634 for viewing exemplary content 632. Exemplary content 632 corresponding to thumbnail for Clip 5 is shown in area 650. FIG. 10 illustrates cursor 1010 for use in navigating the exemplary flowchart. Area 630 includes an edit button 634, ten second preview button 640, and thirty second preview button 642. According to particular embodiments, cursor 1010 may be used to highlight various playback sequences in the flowchart display area, edit various playback sequences, preview various playback sequences, and upload various video clips by selecting a thumbnail in area 650. According to particular embodiments, cursor 1010 may be used to select a preview operation 660 and/or a publish operation 670.

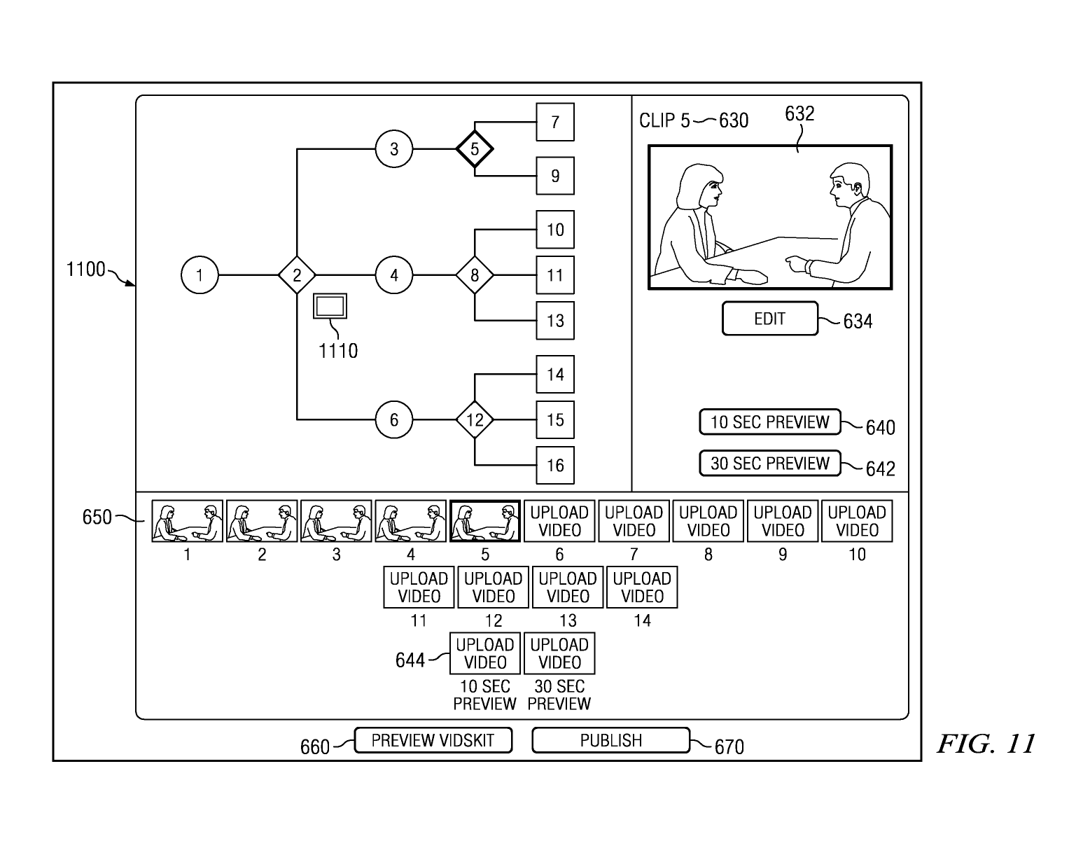

FIG. 11 illustrates an exemplary media content organizer for use in modifying an exemplary flowchart. FIG. 11 illustrates window 1100, which includes a flowchart display area and a media display area 630, which includes a media content viewer 634 for viewing exemplary content 632. Exemplary content 632 corresponding thumbnail for Clip 5 is shown in area 650. FIG. 11 illustrates cursor 1110 for use in navigating the exemplary flowchart. Area 630 includes an edit button 634 and includes a media content viewer 630 for viewing exemplary content 632. Exemplary content 632 corresponds to thumbnail for Clip 5 shown in area 650. FIG. 11 illustrates cursor 1110 for use in navigating the exemplary flowchart. Area 630 includes an edit button 634. Flowchart display area includes a ten second preview button 640, and a thirty second preview button 642. According to particular embodiments, cursor 1110 may be used to rollover ten second preview button 640, and 30 second preview button 642. According to particular embodiments, cursor 1110 may be used to select a preview operation 660 and/or a publish operation 670. According to particular embodiments, cursor 1110 may be used to move a portion of the flowchart, the portion graphically represented by a shape such as a circle, box, triangle or paths for playback sequences, and the portion corresponding to a video clip graphically represented by a thumbnail image.

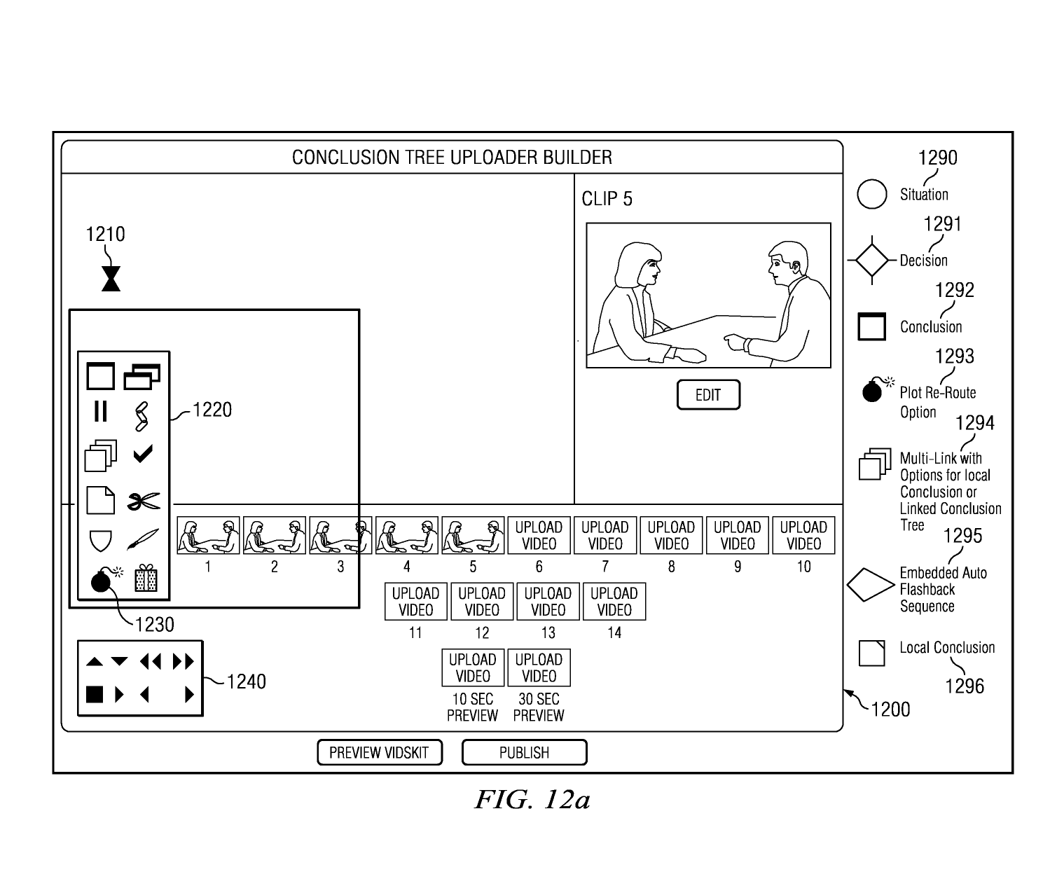

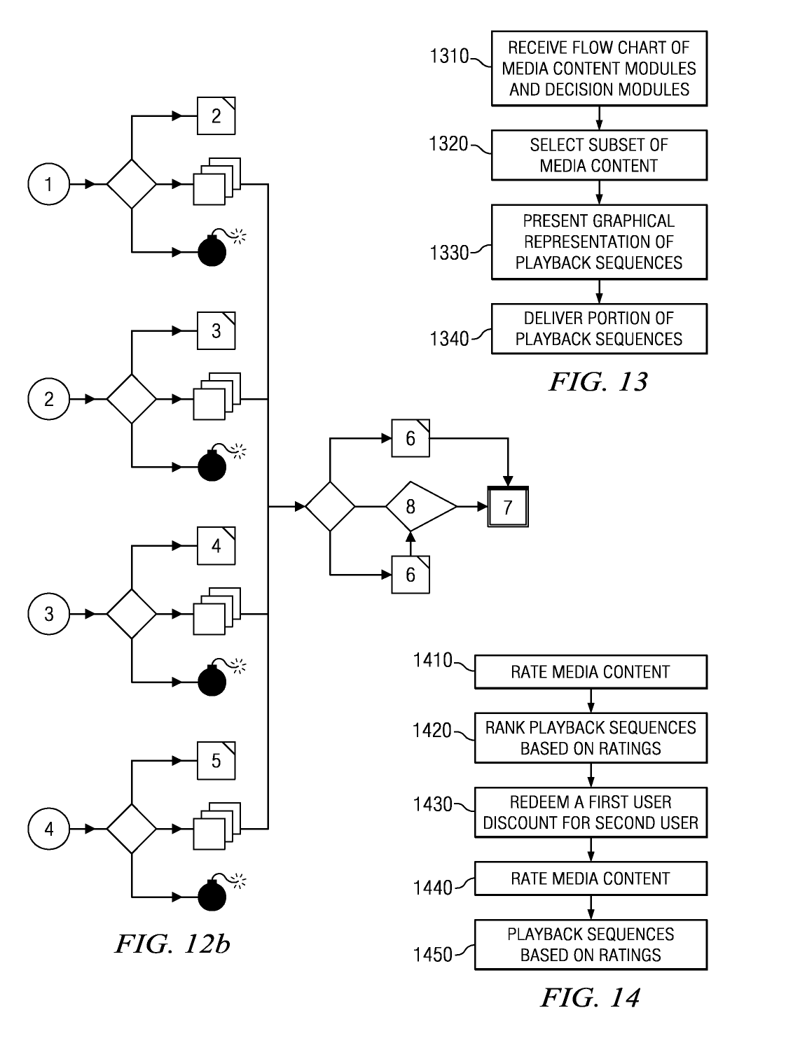

FIG. 12a illustrates an exemplary flowchart tool for use in navigating playback sequences. FIG. 12a illustrates a conclusion tree uploader builder window 1200 for building and/or modifying at least a portion of a flowchart using cursor 1210 to access navigation tools 1220, including plot re-route option 1230, and playback navigation tools 1240. According to particular embodiments, navigation tools 1220 include situation 1290, decision 1291, conclusion 1292, plot re-route option 1293, multi-link with options for local conclusion for link conclusion tree 1294, embedded audio flashback sequence 1295 and local conclusion 1296.

FIG. 12b illustrates an exemplary flowchart for use in navigating playback sequences. An exemplary playback sequence, as illustrated, includes Situation one followed by Decision module for selecting Local conclusion, Multi-Link conclusion tree, or Plot Re-route option. Multi-Link conclusion tree of an exemplary playback sequence includes Decision module for selecting Local conclusion six, Local conclusion six followed by Conclusion seven, or Flashback Sequence eight followed by Conclusion seven. Plot Re-route option enables selection of any one or more of Situations one, two, three and/or four. According to particular embodiments, Flashback Sequence eight generates a flashback sequence using at least a portion of any one or more of Situations one, two, three and/or four.

The illustrations provided and the preceeding descriptions present generic elements for implementing a system for presenting video content. However, while the embodiment illustrated includes specific components arranged in specific ways, it should be understood that this illustration, accompanying description, and all examples given are provided only to aid in clarifying the basic concepts of these techniques and none of these are intended to limit the scope of these concepts.

FIG. 13 illustrates a functional diagram showing the various aspects of a method for presenting media content in an online environment. The exemplary method includes steps to receive flowchart of media content modules and decision modules at step 1310; select subset of media content at step 1320; present graphical representation of playback sequences at step 1330; and deliver portion of playback sequences at step 1340.

According to particular embodiments, step 1310 of the method includes accessing, by a server, a plurality of content from one or more content providers; and receiving, by a content ranking engine, a flowchart for navigating a plurality of playback sequences. According to particular embodiments, step 1320 of the method includes selecting, for example, by a user using a cursor to select or by the organization using any decision logic of content ranking engine to select, a subset such as one module of the flowchart and the one or more playback sequences associated with that module, one playback sequence, one conclusion situation and the playback sequence ending with that conclusion. In step 1330, the method includes presenting, by a graphical user interface, a graphical representation of one or more playback sequences, such as, for example, a highlighted portion of a vidskit map or a sequence of images associated with the media content included in the playback sequences. According to particular embodiments, step 1340 of the method includes delivering, by the content ranking engine, at least a portion of the playback sequences. For example, this step may include delivering content to a media player and/or delivering media content items or representations of media content. According to particular embodiments, an exemplary flowchart includes a plurality of media content modules capable of accessing the content; and a plurality of decision modules for selecting a subset of media content modules. According to particular embodiments, the exemplary flowchart further includes a plurality of second media content modules, wherein one or more second content providers to the online environment load a plurality of secondary content.

While not illustrated in FIG. 13, according to particular embodiments, the method includes automatically selecting, by the content ranking engine, a default playback sequence, wherein the default playback sequence is associated with a first user discount redeemed by a second user and a credited second user account; and, by the content ranking engine, the default playback sequence. According to particular embodiments, the method includes receiving, by the server, one or more feedback ratings of at least a portion of the playback sequences. According to particular embodiments, the method includes ranking the content based on online activity during a competition; and selecting a winning playback sequence based on the highest ranking content.

While not illustrated in FIG. 13, organization 14 registers champions 50 and fans 60. A number of steps may be carried out to register any champion 50 and/or fan 60 for a competition. Registration may be executed at any time prior or during a competition or not at all in some embodiments. For example, champions 50 for a particular competition may include organization 14 and/or organization agent 22. In this example, organization 14 and/or organization agent 22 allocates credits to other user accounts 26 and/or to organization 14 for dispersal that includes artist successes and charitable contributions. When organization 14 registers champions 50 and fans 60, organization 14 may require input of personal information, such as a name and an e-mail address, on a web page using a graphical user interface. At this time, optional information such as demographic information about the artist associated with the champion 50 or being supported by the fan 60. Champion 50 may identify a champion-selected charity to support at this time. Upon entry of at least necessary information, confirmation may be displayed to and/or sent to the registered user. Users may update user profiles at any time. Optionally, organization 14 may prevent users from altering their promotional codes and/or other identifiers to prevent security fraud.

It should be noted that the foregoing functional aspects may be carried out in any order or not at all.

FIG. 14 illustrates an exemplary method for navigating playback sequences. The exemplary method includes steps to rate media content at step 1410; rank playback sequences based on ratings at step 1420; redeem a first user discount for a second user at step 1430; rate media content at step 1440; and rank playback sequences based on ratings at step 1450.

While not illustrated in FIG. 14, according to particular embodiments, for a content ranking engine that includes a plurality of navigation tools for navigating a plurality of playback sequences, the method may include receiving, by the content ranking engine, a user modified flowchart; storing, in a database, the user modified flowchart; presenting, by a graphical user interface, a graphical representation of the user modified flowchart; and delivering, by the content ranking engine, at least a portion of the navigated playback sequences. According to particular embodiments, the method includes receiving a plurality of user selected media content items and a plurality of user selected decisions; and communicating a media product for playback by one or more media players, the media product comprising a first portion of the content, the first portion corresponding to particular ones of the media content modules based on the user selected media content items; and a second portion of the content, the second portion corresponding to particular ones of the subset of media content modules based on the user selected decisions. According to particular embodiments, the method includes providing a cursor for rollover of at least a portion of the flowchart; presenting a sequence of images associated with at least one of the media content modules based on a rollover by the cursor of the portion of the flowchart; receiving the portion of the flowchart; associating the portion of the flowchart with one of the playback sequences; and rating the associated one of the playback sequences.

While not illustrated in FIG. 14, according to particular embodiments, organization 14 rates the media content and/or playback sequences using content ranking engine 16, for example, according to business functions 34. A number of steps may be carried out to rate content in a competition based on fan resonance ratings. Exemplary fan resonance ratings may include ratings based on information collected from a telepresence system, a kiosk, an information booth, a product promotion display, and/or other information collecting equipment. According to particular embodiments, fan resonance ratings may include ratings based on sensory information such as eye activity, noise levels, facial activity, and/or facial expressions collected from one or more fans. According to particular embodiments, fan resonance ratings may include ratings based on retail applications and/or consumer information.

According to particular embodiments, fan resonance ratings may include ratings based on one or more free floating images in a communications system such as a telepresence system using a communication network. For example, the telepresence system could display prerecorded images of a life-size person to communicate messages within a flowchart and/or to promote and/or communicate a particular playback sequence and/or media content. As another example, the telepresence system could transmit a person from a telepresence operations center to engage in two-way telepresence communication with viewers of the media content presented using a flowchart. Presence of a transmitted person transmitted using a telepresence system is useful for many business applications and making business decisions. For example, film studio applications can provide eye contact between a director and a test audience. This eye contact is important in determining an audience's reaction to a scene in a movie. In this example, a director may compare the audience's reactions as between multiple playback sequences. According to particular embodiments, a telepresence system may be used to display media content such as optional content, previews of content, and graphics to support the presentation activity such as thumbnail images of the content. In some configurations, various elements of the telepresence system can be incorporated into various elements of the media content delivery system.

It should be noted that the foregoing functional aspects may be carried out in any order or not at all.

The illustrations provided and the preceeding descriptions present generic elements for implementing systems, methods and apparatus for presenting video content. However, while the embodiment illustrated includes specific components, arranged in specific ways, it should be understood that this illustration, accompanying description, and all examples given are provided only to aid in clarifying the basic concepts of these techniques and none of these are intended to limit the scope of these concepts.

What is claimed is:

1. A method for presenting a plurality of media content in an online environment accessible by a plurality of users, the method comprising:
accessing, by a server, a first plurality of content from one or more first content providers;
receiving, by a content ranking engine, a flowchart for navigating a plurality of playback sequences, the flowchart comprising:
a first plurality of media content modules operable to access the first plurality of content; and
a plurality of decision modules for selecting and ordering a subset of the first plurality of media content;
presenting, by a graphical user interface, a graphical representation of the playback sequences; and
delivering, by the content ranking engine, a portion of the playback sequences, the portion corresponding to the content accessed by the selected and ordered subset of the first plurality of media content modules.

2. The method of claim 1, wherein the flowchart further comprises a plurality of second media content modules, wherein one or more second content providers to the online environment load a plurality of secondary content.

3. The method of claim 1, further comprising:
automatically selecting, by the content ranking engine, a default playback sequence, wherein the default playback sequence is associated with a first user discount redeemed by a second user and a credited second user account; and
delivering, by the content ranking engine, the default playback sequence.

4. The method of claim 1, further comprising:
receiving, by the server, one or more feedback ratings of at least a portion of the playback sequences.

5. The method of claim 1, further comprising:
ranking the content based on online activity during a competition; and
selecting a winning playback sequence based on the highest ranking content.

6. The method of claim 1, wherein the content ranking engine further comprises a plurality of navigation tools for navigating a plurality of playback sequences.

7. The method of claim 6, further comprising:
receiving, by the content ranking engine, a user modified flowchart;
storing, in a database, the user modified flowchart;
presenting, by a graphical user interface, a graphical representation of the user modified flowchart; and
delivering, by the content ranking engine, at least a portion of the navigated playback sequences.

8. The method of claim 1, further comprising:
receiving a plurality of user selected media content items and a plurality of user selected decisions; and
communicating a media product for playback by one or more media players, the media product comprising:
a first portion of the content, the first portion corresponding to particular ones of the media content modules based on the user selected media content items; and
a second portion of the content, the second portion corresponding to particular ones of the subset of media content modules based on the user selected decisions.

9. The method of claim 1, further comprising:
providing a cursor for rollover of at least a portion of the flowchart;
presenting a sequence of images associated with at least one of the media content modules based on a rollover by the cursor of the portion of the flowchart;
receiving the portion of the flowchart;
associating the portion of the flowchart with one of the playback sequences; and
rating the associated playback sequence.

10. A system for presenting in an online environment accessible by a plurality of users a plurality of media content comprising:
a server computer system operable to store in one or more databases a plurality of flowcharts and a plurality of navigation tools, each of the flowcharts comprising a plurality of playback sequences, each of the playback sequences comprising a plurality of media content modules and a plurality of decision modules;
wherein the server computer system is further operable to store in one or more databases a plurality of user profiles and a plurality of user accounts; and
a content ranking engine coupled to the one or more databases using a communication network, the content ranking engine operable to:
rate the media content modules;
rank the playback sequences based on a plurality of ratings, wherein one or more of the ratings is based at least in part on a first user account, the first user account comprising:
a first portion in exchange for hosting the user account;
a second portion in exchange for one or more first user credits for online activity; and
a third portion in exchange for one or more first user discounts for recruiting one or more second users of the online environment; and
receive a second action from a second user using a second user account, wherein another one or more of the ratings is based at least in part on particular ones of the one or more first user discounts redeemed by the second user.

11. The system of claim 10, wherein the content ranking engine is further operable to:
receive a modified flowchart from a first user; and
rate the modified flowchart.

12. The system of claim 10, wherein the second user account comprises:
a first portion in exchange for hosting the second user account;
a second portion in exchange for one or more second user credits for online activity;
a third portion in exchange for one or more second user discounts for recruiting one or more third users of the online environment;
a fourth portion for payment of at least one referral fee; and
wherein the content ranking engine is further operable to rate at least one other playback sequence based on an amount corresponding to at least a portion of the referral fee.

13. The system of claim 10, wherein at least one rating is based on fan resonance.

14. The system of claim 10, wherein the content ranking engine is further operable to:
rank the playback sequences during a competition; and
select a winning playback sequence based on the highest ranking one of the playback sequences.

15. A non-transitory computer readable storage medium with an executable program for presenting in an online environment accessible by a plurality of users a plurality of media content stored thereon, wherein the executable program instructs a processor to perform the following steps:
access, by a server, a first plurality of content from one or more first content providers;
receive, by a content ranking engine, a flowchart for navigating a plurality of playback sequences, the flowchart comprising:
a first plurality of media content modules operable to access the first plurality of content; and
a plurality of decision modules for selecting and ordering a subset of the first plurality of media content;
present, by a graphical user interface, a graphical representation of the playback sequences; and
deliver, by the content ranking engine, a portion of the playback sequences, the portion corresponding to the content accessed by the selected and ordered subset of the first plurality of media content modules.

16. The computer readable storage medium of claim 15, wherein the executable program instructs the processor to perform the following additional steps:
rate the media content modules;
rank the playback sequences based on a plurality of ratings, wherein one or more of the ratings is based at least in part on a first user account, the first user account comprising:
a first portion in exchange for hosting the user account;
a second portion in exchange for one or more first user credits for online activity; and
a third portion in exchange for one or more first user discounts for recruiting one or more second users of the online environment; and
receive a second action from a second user using a second user account, wherein another one or more of the ratings is based at least in part on particular ones of the one or more first user discounts redeemed by the second user.

17. The computer readable storage medium of claim 15, wherein the second user account comprises:
a first portion in exchange for hosting the second user account;
a second portion in exchange for one or more second user credits for online activity;
a third portion in exchange for one or more second user discounts for recruiting one or more third users of the online environment;
a fourth portion for payment of at least one referral fee; and
wherein the content ranking engine is further operable to rate at least one other playback sequence based on an amount corresponding to at least a portion of the referral fee.

18. The computer readable storage medium of claim 18, wherein at least one rating is based on fan resonance.

19. The computer readable storage medium of claim 18, wherein the content ranking engine is further operable to:
rank the playback sequences during a competition; and
select a winning playback sequence based on the highest ranking one of the playback sequences.

20. The computer readable storage medium of claim 18, wherein the flowchart further comprises a plurality of second media content modules, wherein one or more second content providers to the online environment load a plurality of secondary content.
